(19) United States
(12) Patent Application Publication
(10) Pub. No.: US 2024/0427224 A1
(43) Pub. Date: Dec. 26, 2024

(54) LASER LIGHT SOURCE APPARATUS AND LASER PROJECTION SYSTEM

(71) Applicant: HISENSE LASER DISPLAY CO., LTD., Shandong (CN)

(72) Inventors: Wei LI, Shandong (CN); Xiaoqiang GU, Shandong (CN)

(21) Appl. No.: 18/829,072

(22) Filed: Sep. 9, 2024

Related U.S. Application Data
(63) Continuation-in-part of application No. PCT/CN2023/080713, filed on Mar. 10, 2023.

(30) Foreign Application Priority Data
Mar. 10, 2022 (CN) 202210233996.5

(51) Int. Cl. G03B 21/20

(52) U.S. Cl. CPC G03B 21/208; G03B 21/2013; G03B 21/2033; G03B 21/2066

(57) ABSTRACT

Provided is a laser light source apparatus, including a laser device and a fly-eye lens component. The laser includes at least two different colors of laser chips. The fly-eye lens component includes a plurality of microlenses arranged in an array. Each of the microlenses extends along a first dimensional direction and a second dimensional direction. A laser spot emitted from the laser device to a light-incident side of the fly-eye lens component has a smaller NA value in a slow axis direction than an NA value of at least one of the microlenses in the first dimensional direction, and has a smaller NA value in the fast axis direction than the NA value of at least one of the microlenses in the second dimensional direction.

This application is a continuation-in-part application of PCT Application No. PCT/CN2023/080713, filed on Mar. 10, 2023, claims priority to Chinese patent application No. 202210233996.5, filed on Mar. 10, 2022, and entitled “LASER LIGHT SOURCE APPARATUS AND LASER PROJECTION SYSTEM”, all of which are hereby incorporated by reference in their entireties for all purposes.

### TECHNICAL FIELD

The present disclosure relates to the field of projection display technologies, and in particular, relates to a laser light source apparatus and a laser projection system.

### BACKGROUND

With the popularity of laser display products, a laser projection system requires three colors of laser light to achieve a full-color display. The three colors of laser light are modulated and incident to a projection lens for imaging by the projection lens, and color images can eventually be seen because of the retention effect of human eyes.

A Laser device currently used is integrated with different colors of laser chips, and laser beams emitted from different colors of laser chips have different optical properties, such as the light-emitting angle, which easily causes poor light spot uniformity and poor color performance during light-combining, thereby ultimately affecting the projection screen display.

### SUMMARY

The present disclosure provides a laser light source apparatus and a laser projection system. The technical solutions are as follows.

In an aspect, a laser light source apparatus is provided. The laser light source apparatus includes:
a laser device configured to emit different colors of laser light, wherein the laser device includes at least two different colors of laser chips, the laser chips being arranged in line, and fast axis directions of laser light emitted from the laser chips being parallel to each other; and
a fly-eye lens component disposed in a light path of the laser device, wherein the fly-eye lens component includes a plurality of microlenses arranged in an array, and each of the microlenses extends along a first dimensional direction and a second dimensional direction, the second dimensional direction being perpendicular to the first dimensional direction;
wherein a laser spot emitted from the laser device to a light-incident side of the fly-eye lens component has an NA value in a slow axis direction and an NA value in a fast axis direction, the NA value in the slow axis direction is less than an NA value of at least one of the microlenses in the first dimensional direction, and the NA value in the slow axis direction is less than an NA value of at least one of the microlenses in the second dimensional direction; the fast axis direction of the laser spot is parallel to the first dimensional direction, and the slow axis direction of the laser spot is parallel to the second dimensional direction; and a Lagrangian invariant of a laser beam in the fast axis direction is smaller than a Lagrangian invariant of the laser beam in the slow axis direction.

In another aspect, a laser projection system is provided. The laser projection system includes a laser light source apparatus,
a light valve modulation component disposed on a light-output side of the laser light source apparatus, and
a projection lens disposed on a light-output side of the light valve modulation component; wherein
the laser light source apparatus includes:
a laser device configured to emit different colors of laser light, wherein the laser device includes at least two different colors of laser chips, the laser chips being arranged in line, and fast axis directions of laser light emitted from the laser chips being parallel to each other; and
a fly-eye lens component disposed in a light path of the laser device, wherein the fly-eye lens component includes a plurality of microlenses arranged in an array, and each of the microlenses extends along a first dimensional direction and a second dimensional direction, the second dimensional direction being perpendicular to the first dimensional direction;
wherein a laser spot emitted from the laser device to a light-incident side of the fly-eye lens component has an NA value in a slow axis direction and an NA value in a fast axis direction, the NA value in the slow axis direction is less than an NA value of at least one of the microlenses in the first dimensional direction, and the NA value in the slow axis direction is less than an NA value of at least one of the microlenses in the second dimensional direction; the fast axis direction of the laser spot is parallel to the first dimensional direction, and the slow axis direction of the laser spot is parallel to the second dimensional direction; and a Lagrangian invariant of a laser beam in the fast axis direction is smaller than a Lagrangian invariant of the laser beam in the slow axis direction.

### BRIEF DESCRIPTION OF DRAWINGS

For clearer descriptions of the technical solutions in the embodiments of the present disclosure, the following briefly introduces the accompanying drawings required for describing the embodiments. The accompanying drawings in the following descriptions show merely some embodiments of the present disclosure, and persons of ordinary skill in the art may still derive other drawings from these accompanying drawings without creative effort.

FIG. 1 is a schematic structural diagram of a laser light source apparatus according to some embodiments of the present disclosure;

FIG. 2 is a top view of a structure of a laser device according to some embodiments of the present disclosure;

FIG. 3 is a top view of a structure of another laser device according to some embodiments of the present disclosure;

FIG. 4 is a schematic diagram of a principle of emitting laser light by a laser chip according to some embodiments of the present disclosure;

FIG. 5 is a schematic diagram of an arrangement of laser spots emitted from the laser device shown in FIG. 2;

FIG. 6 is a schematic diagram of an arrangement of laser spots emitted from the laser device shown in FIG. 2 after light beams are combined;

FIG. 7 is a schematic structural diagram of a laser light source apparatus according to some embodiments of the present disclosure;

FIG. 8 is a schematic diagram of a correspondence between a fly-eye lens and a laser spot according to some embodiments of the present disclosure;

FIG. 9 is a schematic structural diagram of a fly-eye lens according to some embodiments of the present disclosure;

FIG. 10 is a schematic structural diagram of a fly-eye lens array according to some embodiments of the present disclosure;

FIG. 11 is a schematic structural diagram of another laser light source apparatus according to some embodiments of the present disclosure;

FIG. 12 is a schematic diagram of an arrangement of the laser spots shown in FIG. 6 after beam shrinking;

FIG. 13 is a schematic structural diagram of yet another laser light source apparatus according to some embodiments of the present disclosure;

FIG. 14 is a schematic structural diagram of yet another laser light source apparatus according to some embodiments of the present disclosure;

FIG. 15 is a schematic structural diagram of yet another laser light source apparatus according to some embodiments of the present disclosure;

FIG. 16 is a schematic structural diagram of yet another laser light source apparatus according to some embodiments of the present disclosure;

FIG. 17 is a schematic structural diagram of yet another laser light source apparatus according to some embodiments of the present disclosure;

FIG. 18 is a schematic structural diagram of yet another laser light source apparatus according to some embodiments of the present disclosure;

FIG. 19 is a schematic structural diagram of yet another laser light source apparatus according to some embodiments of the present disclosure;

FIG. 20 is a schematic diagram of a planar structure of a diffusion component according to some embodiments of the present disclosure; and

FIG. 21 is a schematic structural diagram of a laser projection system according to some embodiments of the present disclosure.

### REFERENCE NUMERALS

1—laser light source apparatus, 2—imaging lens group, 3—light valve modulation component, 4—projection lens, 11—laser device, 12—collimating lens, 13—light-combining lens group, 131—first light-combining lens, 132—second light-combining lens, 14—fly-eye lens component, s—microlens, 15—shaping lens group, 151—cylindrical convex lens, 152—cylindrical concave lens, 16—diffusion component, d1-d2—first flip axis, d3-d4—second flip axis, k1—fast axis direction, k2—slow axis direction, a—laser spot, B—laser spot row, x—laser chip, xr—red laser chip, xg—green laser chip, and xb—blue laser chip.

### DETAILED DESCRIPTION

To make the purposes, technical solutions, and advantages of the present disclosure clearer, the embodiments of the present disclosure will be described in further detail below in conjunction with the accompanying drawings. However, the example embodiments may be implemented in a variety of forms and should not be construed as being limited to the embodiments set forth herein; rather, these embodiments are provided to make the present disclosure more comprehensive and complete and to convey the concepts of the example embodiments to those skilled in the art in a comprehensive manner. The same reference numerals in the drawings denote the same or similar structures, and thus repetitive descriptions of them are omitted. The words expressing position and orientation in the present disclosure are illustrated by taking the accompanying drawings as examples, and changes may be made as required, and the changes made are all included in the scope of protection of the present disclosure. The accompanying drawings in the present disclosure are only used to illustrate the relative positional relationship, but do not represent the true proportion.

Projection display is a method in which a light source is controlled by flat image information and an optical system and projection space are used to magnify and display an image on a projection screen. With the development of projection display technologies, projection display is gradually applied to business activities, conferences and exhibitions, scientific education, military command, traffic management, centralized monitoring and advertising entertainment, and other fields. The projection display has the advantages of a large screen size, clear display, and the like, and also meets the requirements of a large screen display.

At present, the mainstream laser projection systems mainly have two display forms, one is a time-sharing display by using a monochrome laser device together with a color wheel, and the other one is a three primary color display by using a three-color laser device. Due to the visual inertia of human eyes, primary colors alternately irradiating the same pixel point at a high speed are mixed and superimposed, and thus colors can be viewed.

The projection system using monochrome laser devices has a relatively big advantage in terms of cost, but the brightness of monochrome laser devices is relatively limited. Currently, the laser device integrated with a plurality colors of laser chips can emit a plurality colors of laser light, and the laser light has high brightness. For example, small-size laser devices (multi-chip LD, short for MCL), which occupy smaller space and are conducive to the development of miniaturization of laser light source modules, are the development trend of the laser projection systems. MCL laser devices have the advantages of long life, high brightness, high power, and the like. An MCL laser device can replace a plurality of BANK laser devices and can package chips emitting different colors of light in the same MCL laser device, thereby achieving the functions of various monochrome laser devices.

For the current MCL laser devices and other laser devices that are integrated with different colors of laser chips, the laser beams emitted from the laser chips have different dispersion angles in the fast and slow axes, and the laser beams emitted from different colors of laser chips also have different dispersion angles in the fast and slow axes. As a result, there is a difference in the laser spots emitted from different colors of laser chips, and the homogenization uniformity is poor in the subsequent homogenization process.

In view of the above, the embodiments of the present disclosure provide a laser light source apparatus, which can optimize the homogenization effect of laser light.

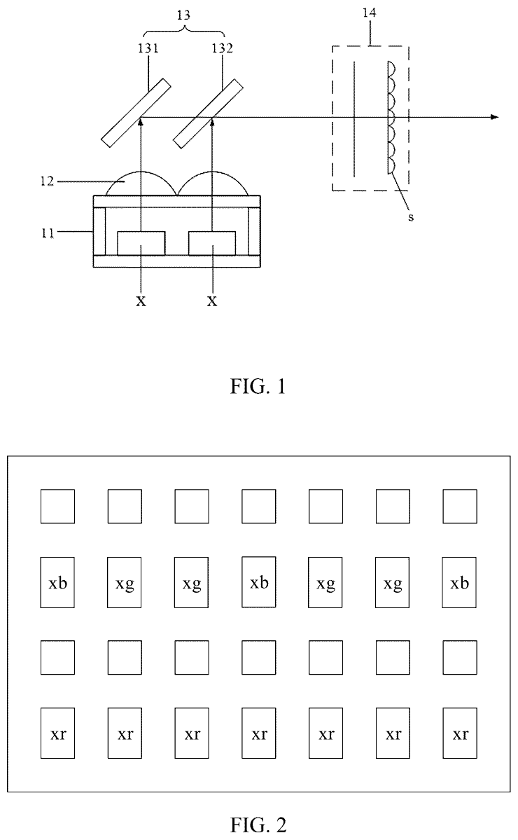

FIG. 1 is a schematic structural diagram of a laser light source apparatus according to some embodiments of the present disclosure.

As shown in FIG. 1, the laser light source apparatus includes a laser device 11, a collimating lens 12, a light-combining lens group 13, and a fly-eye lens component 14.

The laser device 11 includes at least two different colors of laser chips x, and the different colors of laser chips x are configured to emit different colors of laser light.

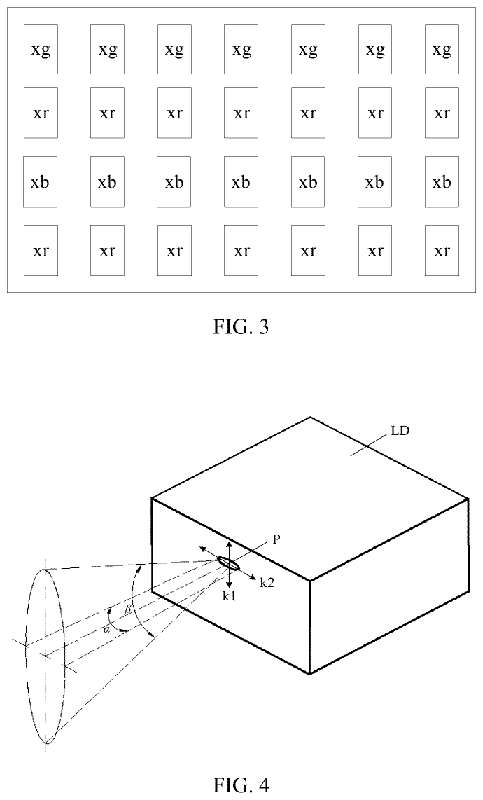

FIG. 2 is a top view of a structure of a laser device according to some embodiments of the present disclosure; and FIG. 3 is a top view of a structure of another laser device according to some embodiments of the present disclosure.

As shown in FIG. 2 and FIG. 3, the laser chips are arranged in line. In practice, the laser device 11 usually includes three different colors of laser chips, i.e., red laser chips xr, green laser chips xg, and blue laser chips xb. The red laser chips xr, the green laser chips xg, and the blue laser chips xb are arranged in an array, and the red laser chips xr, the green laser chips xg, and the blue laser chips xb are arranged in at least one row.

In a specific implementation, the red laser light is produced by gallium arsenide light-emitting materials, the blue laser light and the green laser light are produced by gallium nitride light-emitting materials, and different light-emitting materials have different light-emitting mechanisms. Therefore, in the process of producing different colors of laser light, the visible efficiency of the red laser chip xr is lower, and the visible efficiencies of the blue laser chip xb and the green laser chip xg are higher. To achieve a certain brightness, the number of the red laser chips xr needs to be greater than both the number of the green laser chips xg and the number of the blue laser chips xb.

Additionally, the number of the red laser chips xr cannot be significantly greater than the number of the green laser chips xg and the number of the blue laser chips xb. In some embodiments, the number of the red laser chips xr is less than or equal to twice the sum of the number of the green laser chips xg and the number of the blue laser chips xb. Understandably, the number of each color of laser chips is not limited in the embodiments of the present disclosure.

Different colors of laser chips in the laser device may be arranged in an array according to different rules. In the embodiments of the present disclosure, different colors of laser chips may be arranged in an array as follows: the red laser chips, the green laser chips, and the green laser chips are arranged in one row; the red laser chips are arranged in one row, and the green laser chips and the blue laser chips are arranged in one row; and red laser chips are arranged in two rows, the green laser chips are arranged in one row, and the blue laser chips are arranged in one row.

Exemplarily, in the case that the red laser chips, the green laser chips, and the green laser chips are arranged in two rows, the combination may be seven red laser chips arranged in one row, and fourth green laser chips and three blue laser chips are arranged in the other row; or four red laser chips are arranged in one row, and three green laser chips and two blue laser chips are arranged in the other row; or five red laser chips are arranged in one row, and three green laser chips and two blue laser chips are arranged in the other row; or two red laser chips are arranged in one row, and one green laser chip and one blue laser chip are arranged in the other row.

Taking the MCL laser device shown in FIG. 2 as an example, the red laser chips xr, the green laser chips xg, and the blue laser chips xb are arranged in two rows, with seven laser chips in each row. The red laser chips xr are arranged in one row, and the green laser chips xg and the blue laser chips xb are arranged in one row.

Specifically, the laser device includes seven red laser chips xr, four green laser chips xg, and three blue laser chips xb. The seven red laser chips xr are arranged in one row, and the four green laser chips xg and the three blue laser chips xb are arranged in one row. Exemplarily, as shown in FIG. 2, the four green laser chips xg and the three blue laser chips xb in the same row are arranged alternately. Certainly, the four green laser chips xg and the three blue laser chips xb in the same row may also be arranged in other manners. For example, the three blue laser chips xb are arranged in the middle, and the four green laser chips xg are arranged on two sides of the three blue laser chips xb, respectively, which is not limited herein.

Taking the MCL laser device shown in FIG. 3 as an example, the red laser chips xr, the green laser chips xg, and the blue laser chips xb are arranged in four rows, with seven laser chips in each row. The red laser chips xr are arranged in two rows, the green laser chips xg are arranged in one row, and the blue laser chips xb are arranged in one row.

Specifically, the laser device includes fourteen red laser chips xr, seven green laser chips xg, and seven blue laser chips xb. The fourteen red laser chips xr are arranged in two rows, the seven green laser chips xg are arranged in one row, and the seven blue laser chips xb are arranged in one row. Exemplarily, as shown in FIG. 3, one blue laser chip row is disposed between the two red laser chip rows. Certainly, one green laser chip row may also be disposed between the two red laser chip rows, which is not limited herein.

In practice, the different colors of laser chips in the laser device may also be arranged according to other rules. The embodiments of the present disclosure are only illustrated by taking the MCL laser device as an example, and the arrangement rule of the laser chips in the laser device is not limited.

Different colors of laser chips in the laser device may be packaged in different ways. For example, the red laser chips, the green laser chips, and the blue laser chips are packaged together in one housing; or, the red laser chips, the green laser chips, and the blue laser chips are packaged in two separate housings, e.g., the red laser chips are packaged in one housing, and the green laser chips and the blue laser chips are packaged in the other housing. In practice, the way of packaging the laser chips can be determined based on the sizes of the lasers, which is not limited herein.

Different colors of laser chips are configured to emit different colors of laser light. The red laser chips emit red laser light, the green laser chips emit green laser light, and the blue laser chips emit blue laser light. Different colors of laser chips have the same principle of emitting laser light. FIG. 4 is a schematic diagram of laser spots at positions of the light-output sides of a plurality of laser chips. As shown in FIG. 4, the front cavity of the laser chip LD has a light-emitting point P, and laser beams are emitted in the form of radial beams from the light-emitting point P. In the figure, a and B represent the divergence angle in the slow axis direction k2 and the divergence angle in the fast axis direction k1, respectively. For the blue laser light and the green laser light, the value of a ranges from 3 to 9 degrees, and the value of β ranges from 20 to 45 degrees; for the red laser light, the value of a ranges from 5 to 12 degrees, and the value of β ranges from 25 to 68 degrees. As shown in FIG. 4, the laser light diverges faster in the fast axis direction k1 and the divergence angle is larger; and the laser light diverges slower in the slow axis direction k2 and the divergence angle is smaller, that is, the laser light has a larger divergence angle in the fast axis direction k1 than in the slow axis direction k1. Thus, the laser beams are in the shape of an ellipse.

In the embodiments of the present disclosure, the different colors of laser light emitted from the laser include a red laser beam, a blue laser beam, and a green laser beam. The laser includes different colors of light-emitting chips and collimating lenses corresponding to the different light-emitting chips, and the collimating lenses are generally configured to compress the divergence angles of the laser beams in the slow axis direction and/or the fast axis direction, to achieve the effect that the laser beams emitted from the laser are approximately parallel beams, i.e., to achieve the effect of collimating laser beams in the fast axis direction and/or the slow axis direction. However, in practice, the collimating effect may vary due to the divergence degree of the beams. In the embodiments of the present disclosure, in the three colors of laser beams emitted from the laser, the NA value of the red laser beam in the slow axis direction is greater than the NA value of the blue laser beam in the slow axis direction and the NA value of the green laser beam in the slow axis direction, and the NA value of the red laser beam in the slow axis direction is less than the NA value of at least one of the microlenses in the slow axis direction. Those skilled in the art know that the NA value is the numerical aperture, which is used to describe the range of light collected by the optical system. In laser optics, laser beams are beams with a Gaussian energy distribution, and although beams have a good directionality, they still have a certain divergence angle. It is defined in the formula for the NA value that NA=n*sin θ, where θ is used to represent the divergence angle of a beam. In the embodiments of the present disclosure, the NA value is an indirect parameter used to indicate the divergence degree of a laser beam, such that the parameters of the components in the optical system have a better correspondence or comparison relationship with each other.

In the embodiments of the present disclosure, the fast axis direction and the slow axis direction are two different reference directions defined from the position on the light-output side of the light-emitting chip of the laser device, i.e., the position on the front cavity surface, and the fast axis direction and the slow axis direction are perpendicular to each other. For example, as shown in FIG. 4, the fast axis direction k1 may be the width direction of the front cavity surface of the laser chip LD, and the slow axis direction k2 may be the length direction of the front cavity surface of the laser chip LD. Certainly, in the case that the laser chips are in determinant array arrangement, the fast axis direction k1 may be parallel to the column direction of the plurality of laser chips, and it may be considered that the fast axis direction is consistent with the column direction, and the slow axis direction k2 may be parallel to the row direction of the plurality of laser chips, and it may be considered that the slow axis direction is consistent with the row direction.

It should be noted that, since the light-emitting efficiency of the red laser chip is lower, to satisfy the requirement for the light-emitting power, a plurality of light-emitting points (generally two light-emitting points) need to be set on the red laser chip, while only one light-emitting point is generally set on the blue laser chip and the green laser chip. However, although a plurality of light-emitting points are set, when the red laser beams are used, the laser beams emitted from the two light-emitting points are considered as one laser beam. In this case, the divergence angles of the beams emitted from different light-emitting points are superposed and enlarged. As a result, the size of the red laser beam is relatively large, and the divergence degree of the red laser beam in both the fast axis direction and the slow axis direction is larger than the divergence degree of the blue laser beam and the divergence degree of the green laser beam.

In an embodiment of the present disclosure, the laser chips are in determinant array arrangement, and fast axis directions of the laser light emitted from the laser chips in the laser device are parallel to each other.

As shown in FIG. 1, the collimating lens 12 is disposed on the light-output side of the laser chip x, and is configured to collimate the laser light emitted from the laser chip x. In a specific implementation, one collimating lens 12 corresponds to at least one laser chip x. For example, one collimating lens 12 corresponds to one laser chip x.

The laser chips x are arranged in an array, and accordingly, the collimating lenses 12 are also arranged in an array according to the positions of the laser chips x. The laser chip x is welded to a heat sink, and the laser chip x emits laser light sideways; a reflector is provided on the light-output side of the laser chip x, and the laser light emitted from the laser chip x is reflected by the reflector and then incident to the corresponding collimating lens 12.

In the embodiments of the present disclosure, the fast axis direction may also be the long side direction of the collimating lens 12, and the slow axis direction may also be the short side direction of the collimating lens 12.

As shown in FIG. 1, the light-combining lens group 13 is disposed on the light-output side of the laser device 11, and specifically, is disposed on the light-output side of the collimating lens 12. The light-combining lens group is configured to combine the laser light emitted from the respective rows of laser chips.

Specifically, the light-combining lens group 13 includes a plurality of light-combining lenses, and one row of laser chips at least corresponds to one light-combining lens. After light is reflected and transmitted, a plurality of rows of laser spots can be combined into one row of laser spots. Taking the MCL laser device shown in FIG. 2 as an example, to combine the laser light emitted from three colors of laser chips, the light-combining lens group 13 in FIG. 1 may include a first light-combining lens 131 and a second light-combining lens 132, the first light-combining lens 131 is disposed on the light-output side of the first row of laser chips in FIG. 2, and the second light-combining lens 132 is disposed on the light-output side of the second laser chip in FIG. 2. The first light-combining lens 131 is configured to reflect the green laser light emitted from the green laser chips xg and the blue laser light emitted from the blue laser chips xb towards the second light-combining lens 132, and the second light-combining lens 132 is configured to transmit the green laser light and the blue laser light, and at the same time reflect the red laser light emitted from the red laser chips xr. In this way, the three colors of laser light can be combined.

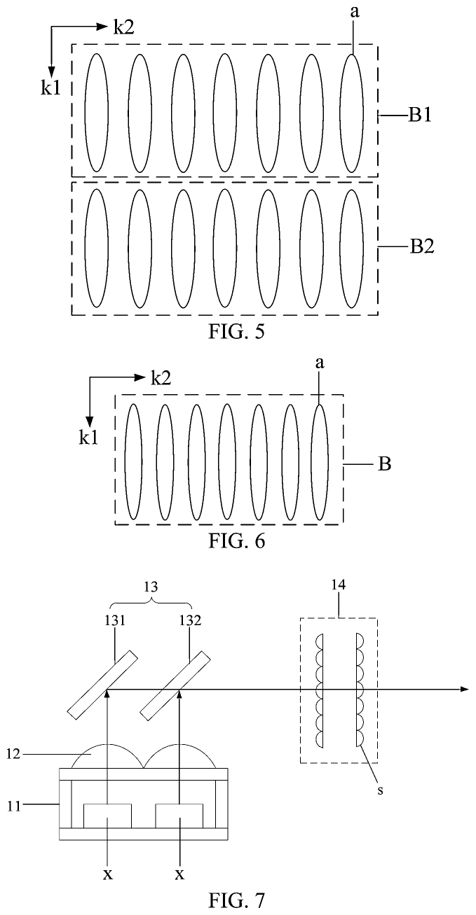

FIG. 5 is a schematic diagram of an arrangement of laser spots emitted from the laser device shown in FIG. 2; and FIG. 6 is a schematic diagram of an arrangement of laser spots emitted from the laser device shown in FIG. 2 after light beams are combined.

The laser device shown in FIG. 2 includes two rows of laser chips, and the laser spots formed after the laser light emitted from the laser chips is collimated by the collimating lens 12 are shown in FIG. 5. Each laser spot a still has different divergence angles in the fast axis direction k1 and the slow axis direction k2. The laser light emitted from the laser chips arranged in one row forms laser spots arranged in one row after passing through the collimating lens, and the two rows of laser chips eventually form two laser spot rows B1 and B2. The laser spot row B1 is formed by the red laser light emitted from the red laser chips, and the laser spot row B2 is formed by the blue laser light emitted from the blue laser chips and the green laser light emitted from the green laser chips. Since the divergence degrees of the red laser spot in the fast axis direction and the slow axis direction are larger, and the number of the red laser chips is also greater than the number of the blue laser chips and the number of the green laser chips in the present example, the size of laser spot row B1 only including the red laser spots is slightly larger than the size of laser spot row B2 including the blue laser spots and the green laser spots. In the present example, the sizes of the laser spot row B1 and the laser spot row B2 are different in the fast axis direction k1 and slow axis direction k2 of the laser light. For example, the length of each spot in laser spot row B1 is 6 mm in the fast axis direction and is 1 mm to 2 mm in the slow axis direction, and the length of each spot in laser spot row B2 is 3 mm in the fast axis direction and is 1 mm to 2 mm in the slow axis direction.

As shown in FIG. 6, after combining the light beams by the light-combining lens group 13, the two laser spot rows (B1 and B2) are combined into one laser spot row B. The individual laser spot a has a larger size in the fast axis direction k1 and a smaller size in the slow axis direction k2. Therefore, in the subsequent homogenization process, when being incident to the homogenizing component, the beam is cut less in the slow axis direction and more in the fast axis direction. Thus, the laser spots can be adequately homogenized in the fast axis direction, but cannot be adequately homogenized in the slow axis direction.

It is to be understood that the more times the light beam is cut when being incident to the homogenizing component, the more effective the homogenization is.

In the embodiments of the present disclosure, the homogenizing component is the fly-eye lens component 14. Specifically, the fly-eye lens component is disposed on the light-output side of the light-combining lens group 13.

As shown in FIG. 1, the fly-eye lens component 14 includes a plurality of microlenses s arranged in an array, and each microlens s extends along a first dimensional direction and a second dimensional direction. The first dimensional direction and the second dimensional direction are perpendicular to each other, and it may be considered that the first dimensional direction and the second dimensional direction are parallel to the two coordinate axis directions of the XY rectangular coordinates, respectively. In an example, the fly-eye lens component 14 includes a substrate and a plurality of microlenses s disposed on the side of the substrate. The plurality of microlenses s are fly-eye lens units projected along an optical axis, and the projected cross-section of each of the microlenses s is rectangular. The first dimensional direction and the second dimensional direction correspond to the long side and the short side of the rectangle. In at least one embodiment of the present disclosure, the laser spot emitted from the laser device to the light-incident side of the fly-eye lens component has an NA value in a slow axis direction and an NA value in a fast axis direction, the NA value in the slow axis direction is less than an NA value of at least one of the microlenses in the first dimensional direction, and the NA value in the slow axis direction is less than an NA value of at least one of the microlenses in the second dimensional direction. In addition, the fast axis direction of the laser spot is parallel to the first dimensional direction, and the slow axis direction of the laser spot is parallel to the second dimensional direction. In the embodiments of the present disclosure, the Lagrangian invariant of the laser beam in the fast axis direction is smaller than the Lagrangian invariant of the laser beam in the slow axis direction. In the embodiments of the present disclosure, the NA value of the microlens is used to characterize the optical system's capability of collecting light. The Lagrangian invariant is a product of the size of a beam image and an angle between a beam and an optical axis in a lens optical system, which is a constant, and is also referred to as an optical invariant. Thus, the Lagrangian invariant may also be considered as an integral value of an area of a spot and a value of a divergence angle function.

It should be noted that the fast axis direction and the slow axis direction of the laser spot may have different correspondences with the row direction and the column direction of the laser chips, such as being parallel or perpendicular. In the case that the fast axis direction of the laser spot is mentioned, it may be considered that the fast axis direction and the slow axis direction are not defined by disassembling the laser device to measure the difference in the divergence angles on the front cavity surface of the light-emitting chip, and the fast axis direction and the slow axis direction correspond to the row direction and the column direction of the laser chips.

Since the laser spot emitted from the laser device to the light-incident side of the fly-eye lens component has a smaller NA value in the slow axis direction than the NA value of at least one of the microlenses in the first dimensional direction and has a smaller NA value in the fast axis direction than the NA value of at least one of the microlenses in the second dimensional direction, the optical etendue of the laser spot is increased in both the fast axis direction k1 and the slow axis direction k2, and the laser spot is homogenized as much as possible, thereby achieving the good homogenizing effect.

In the embodiments of the present disclosure, the NA value may be simply understood as the sine value of the angle of incidence. For example, when the angle of incidence of the laser spot in the slow axis direction is θ₁, the corresponding NA value is sin θ₁; and when the angle of incidence of the laser spot in the fast axis direction is θ₂, the corresponding NA value is sin θ₂.

As shown in FIG. 1, the fly-eye lens component 14 includes a microlens array disposed on the light-output side, and the corresponding light-incident side may be a smooth plane. Alternatively, in some other embodiments of the present disclosure, as shown in FIG. 7, which is a schematic structural diagram of a laser light source apparatus according to some embodiments of the present disclosure, the fly-eye lens component 14 includes two microlens arrays disposed on the light-incident side and the light-output side. Along the light-incident direction, the focal point of each of the microlenses on the light-incident side coincides with the center of the corresponding microlens on the light-output side, and in this case, the optical axes of the two fly-eye microlens arrays are parallel to each other. When a double-sided fly-eye microlens structure is used, the NA value of the laser spot in the slow axis direction is specifically smaller than the NA value of the corresponding covered microlens on the light-incident side in the first dimensional direction, and the NA value of the laser spot in the fast axis direction is specifically smaller than the NA value of the covered microlens on the light-incident side in the first dimensional direction. In some embodiments, microlens arrays on the light-incident side and the microlens arrays on the light-output side generally have a symmetrical relationship. Therefore, the NA value of the laser spot in the slow axis direction is specifically smaller than the NA value of the corresponding covered microlens on the light-output side in the first dimensional direction, and the NA value of the laser spot in the fast axis direction is specifically smaller than the NA value of the covered microlens on the light-output side in the first dimensional direction.

In the embodiments of the present disclosure, the size of the far-field spot formed by the laser light after passing through the fly-eye lens component 14 is positively associated with the Lagrangian invariant. For the laser device, a spot closer to an exit of the laser device is a near-field spot, and a spot farther away from the exit of the laser device is a far-field spot. Both the near-field spot and the far-field spot are used for describing the dimensional and angular information of the laser spot. In the far-field region, the light intensity distribution tends to be uniform, and the size of the spot is determined based on the divergence angle and propagation distance of the spot. In the far-field region, the spot has a relatively stable size and shape, and is suitable for a variety of measurements, imaging, and other applications. Therefore, in the embodiments of the present disclosure, generally, the far-field spot formed by the laser light after passing through the fly-eye lens component is not measured in projection optics, and the far-field spot of the laser spot after passing through the fly-eye lens component may be acquired by leading out the beam passing through the fly-eye lens component through a lens such as a reflector and directing the beam away, e.g., towards at least one meter away from the light-output side of the fly-eye lens. In the embodiments of the present disclosure, the sizes of the far-field spot after passing through the fly-eye lens component are the size of the laser spot in the slow axis direction and the fast-axis direction, or one of the dimensional parameters of the size of the laser spot corresponds to the row direction or the column direction of the laser chips. In the embodiments of the present disclosure, the size of the far-field light spot passing through the fly-eye lens component is positively associated with the Lagrangian invariant, which means that after passing through the fly-eye lens component, the optical etendue of the laser spot increases compared to the size before entering the fly-eye lens component. After passing through the fly-eye lens component, it may be considered that the laser spot is differentiated, and the homogenization effect of the differentiated laser spot is good. For the laser spot, homogenization represents the disruption of the Gaussian energy distribution law, which can reduce the coherence of the laser beam and reduce the scattering phenomenon of the projection picture. At the same time, the homogenization of the spot can also improve the uniformity of the brightness of the projection picture.

In an embodiment of the present disclosure, the size of each of the microlenses in the first dimensional direction is smaller than the size of each of the microlenses in the second dimensional direction. Correspondingly, the short side direction of each of the microlenses is parallel to the fast axis direction of the incident laser spot, and the long side direction of each of the microlenses is parallel to the slow axis direction of the incident laser spot. In another embodiment of the present disclosure, the size of each of the microlenses in the first dimensional direction is larger than the size of each of the microlenses in the second dimensional direction, and in this case, the long side direction of each of the microlenses is parallel to the fast axis direction of the incident laser spot, and the short side direction of each of the microlenses is parallel to the slow axis direction of the incident laser spot.

It is to be noted that the first dimensional direction and the second dimensional direction have been elaborated above by taking an example where the projected cross-section of each of the microlenses is rectangular. In some embodiments, the projected cross-section of each of the microlenses may not be limited to a rectangle, and may also be other polygons, such as a hexagonal shape shown in FIG. 9. FIG. 9 is a schematic structural diagram of a fly-eye lens according to some embodiments of the present disclosure. In the shape shown in FIG. 9, the first dimensional direction is l1, the second dimensional direction is l2, and generally, the size in the first dimensional direction is different from the size in the second dimensional direction. For example, in the example of FIG. 9, the size in the first dimensional direction l1 is larger than the size in the second dimensional direction l2. Thus, for a unified statement, the l1 direction is considered as the long side direction, and the l2 direction is considered as the short side direction.

The following is a description taking an example in which the size of each of the microlenses in the first dimensional direction is larger than the size of each of the microlenses in the second dimensional direction, i.e., the long side direction of each of the microlenses is parallel to the fast axis direction of the incident laser light, and the short side direction of each of the microlenses is parallel to the slow axis direction of the incident laser light.

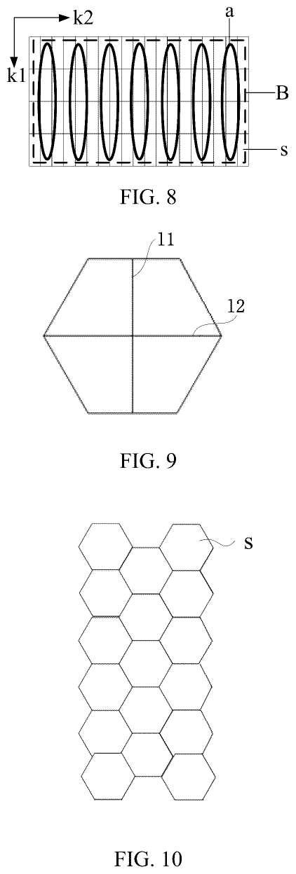

FIG. 8 is a schematic diagram of a correspondence between a fly-eye lens and a laser spot according to some embodiments of the present disclosure. FIG. 10 is a schematic structural diagram of a fly-eye lens array according to some embodiments of the present disclosure.

In the embodiments of the present disclosure, the projection of the outer contour of each of the microlenses s in the fly-eye lens in the optical axis direction is approximately a rectangle, such as a rectangle or a hexagon, so as to adapt the shape of the spot, thereby improving the incidence efficiency and the homogenization effect. As shown in FIG. 8, when the projection of the outer contour of each of the microlenses in the optical axis direction is a rectangle, the long sides of the various microlenses are parallel to each other, and the length-to-width ratio is related to a projection surface of a digital micromirror device (DMD). Take a 0.47″ DMD as an example, the length-to-width ratio of the DMD is 16:9, if the spot is incident from the long side, then the length-to-width ratio of each of the microlenses s is greater than 16:9; if the spot is incident from the short side, then the length-to-width ratio of each of the microlenses s is less than 16:9; and if the spot is incident from the oblique side at 45 degrees, the length-to-width ratio of each of the microlenses s approximates 16:9. As shown in FIG. 8, the laser spot covers more microlenses in the slow axis direction k2 than in the fast axis direction k1. As shown in FIG. 9 and FIG. 10, when the projection of the outer contour of each of the microlenses in the optical axis direction is a hexagon having a short side l1 and a long side l2, the short sides l1 of two adjacent microlenses are in the same straight line or parallel to each other.

In the embodiments of the present disclosure, the laser spot row B after light combination has a larger size in the fast axis direction k1 than in the slow axis direction k2, and each of the microlenses s in the fly-eye lens has a larger size in the long side direction than in the short side direction. By arranging the long side direction of each of the microlenses s to be parallel to the fast axis direction k1 of the incident laser light, and arranging the short side direction of each of the microlenses s to be parallel to the slow axis direction k2 of the incident laser light, the laser spot row B can achieve a better homogenizing effect in both the fast axis direction k1 and the slow axis direction k2, such that the laser light spots can be homogenized and split to the maximum extent in the fast axis direction k1 and the slow axis direction k2, thereby optimizing the homogenizing effect of the fly-eye lens component.

For example, in the case that the size of a single laser spot a after the light combination is 6 mm×1 mm, and the size of a single microlens s in the fly-eye lens is 0.5 mm×0.3 mm, then a single laser spot a corresponds to 6/0.5=12 microlenses in the fast axis direction k1, and corresponds to 1/0.3=3 microlenses in the slow axis direction k2. In this way, the laser spot a can be homogenized and split to the maximum extent in both the fast axis direction k1 and slow axis direction k2.

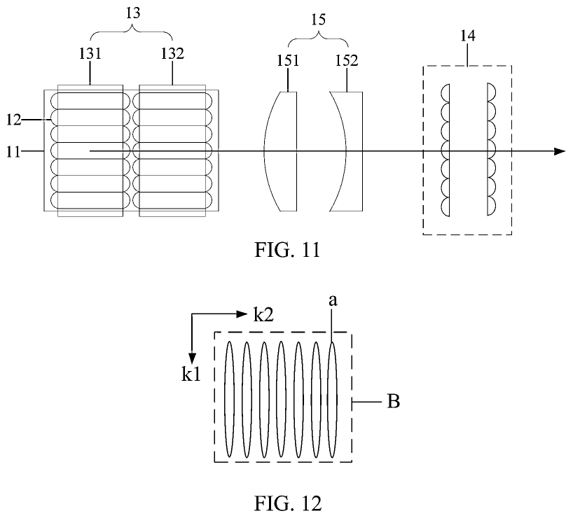

FIG. 11 is an aschematic structural diagram of another laser light source apparatus according to some embodiments of the present disclosure.

As shown in FIG. 11, in some embodiments, the laser light source apparatus further includes a shaping lens group 15. The shaping lens group 15 is disposed on the light-output side of the light-combining lens group 13, and the fly-eye lens component 14 is disposed on a side of the shaping lens group 15 away from the light-combining lens group 13. The shaping lens group 15 is configured to shape the laser light emitted from the light-combining lens group 13.

When the fly-eye lens component is used for homogenization, the light spots incident to the fly-eye lens component generally need to be relatively even in all directions, while the light spots of the laser light emitted from the laser after light combination are shown in FIG. 6, and have a big difference in the fast axis direction k1 and the slow axis direction k2 of the laser light. Therefore, in the embodiments of the present disclosure, before the laser light is incident to the fly-eye lens component 14, the shaping lens group 15 is provided to shrink the laser light, thereby making the sizes of the laser spots that pass through the shaping lens group 15 approximately the same in the fast axis direction and the slow axis direction, which helps optimize the homogenizing effect of the fly-eye lens component on the laser light.

FIG. 12 is a schematic diagram of an arrangement of the laser spots shown in FIG. 6 after beam shrinking.

The entire laser spot row B has a larger size in the slow axis direction k2 than in the fast axis direction k1 in FIG. 6, whereas after the beam shrinking by the shaping lens group 15, as shown in FIG. 12, the differentiation between the size of the entire laser spot row B in the slow axis direction k2 and the size of the entire laser spot row B in the fast axis direction k1 is reduced and remains rectangular.

In some embodiments, as shown in FIG. 11, the shaping lens group 15 includes a cylindrical convex lens 151 and a cylindrical concave lens 152. The cylindrical convex lens 151 is disposed on a side close to the light-combining lens group 13, and the cylindrical concave lens 152 is disposed on a side of the cylindrical convex lens 151 away from the light-combining lens group 13. The cylindrical axial directions of the cylindrical convex lens 151 and the cylindrical concave lens 152 are parallel to the fast axis direction of the incident laser light, so as to reduce the difference between the sizes of the laser spot in the fast axis direction and in the slow axis direction after beam shrinking. It is to be understood that the cylindrical lens is a part of a cylindroid, and the cylindrical axial direction refers to the height direction of the cylindroid in the embodiments of the present disclosure.

For the entire laser spot row B shown in FIG. 6, the beam shrinking only needs to be performed in the slow axis direction k2, so as to reduce the size of the entire laser spot row B in the slow axis direction k2 and to be the same as the size in the fast axis direction k1. Therefore, only two lenses in the shaping lens group 15 need to be cylindrical, and the cylindrical axial directions of the cylindrical lenses are parallel to the fast axis direction k1, thereby shrinking the beams in the slow axis direction k2.

In some embodiments, the shaping lens group 15 includes a convex lens and a concave lens. The convex lens is disposed on a side close to the light-combining lens group, and the concave lens is disposed on a side of the convex lens away from the light-combining lens group. The axial directions of the convex lens and the concave lens are parallel to the fast axis direction of the incident laser light, which can reduce the difference between the sizes of the laser spot in the fast axis direction and in the slow axis direction after the beam shrinking.

In some embodiments, the shaping lens group 15 includes a first convex lens and a second convex lens mirror. The first convex lens and the second convex lens are confocal, and the first convex lens and the second convex lens form a Kepler illumination lens group.

Accordingly, the shaping lens group 15 in the plurality of examples described above can shrink or expand the laser beams emitted from the laser in at least one of the fast axis and the slow axis.

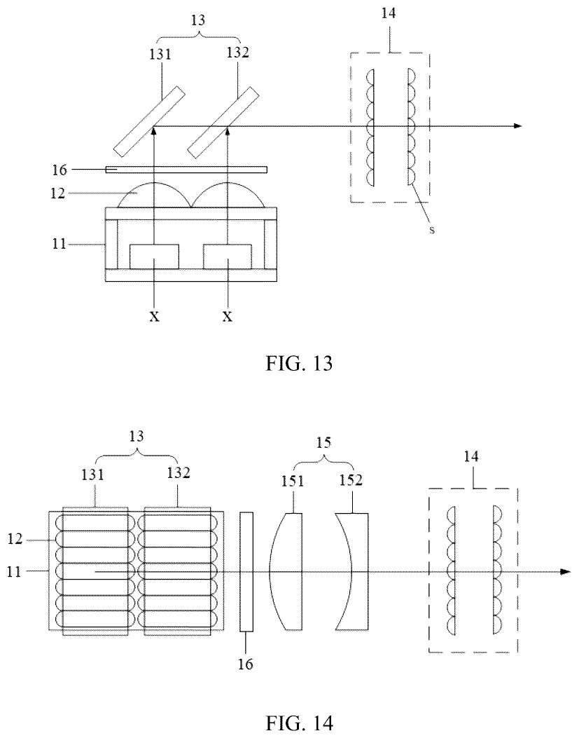

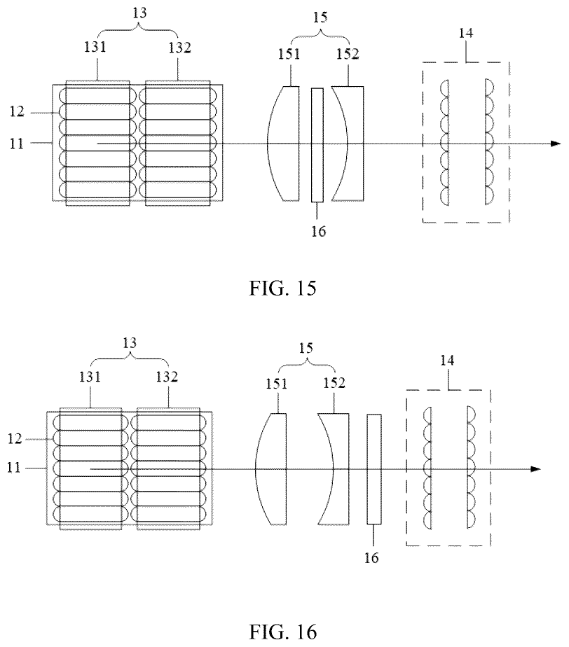

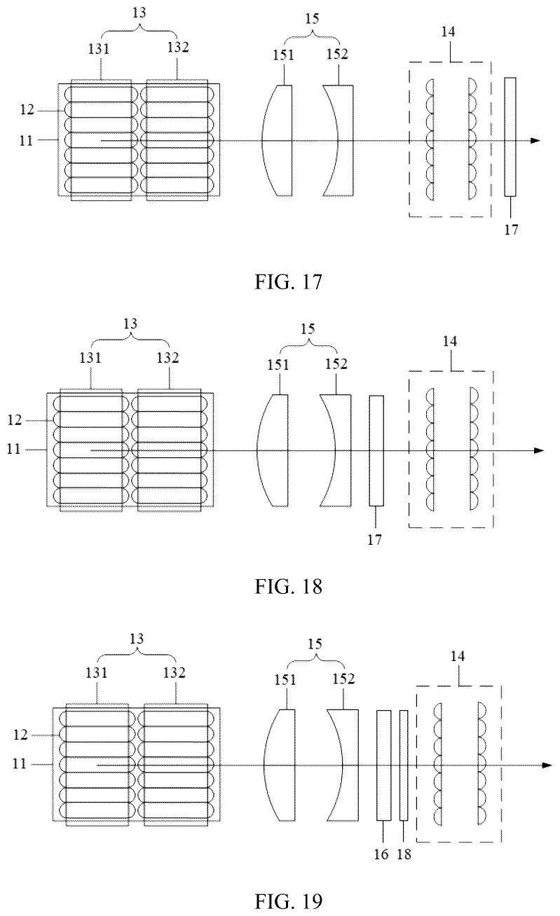

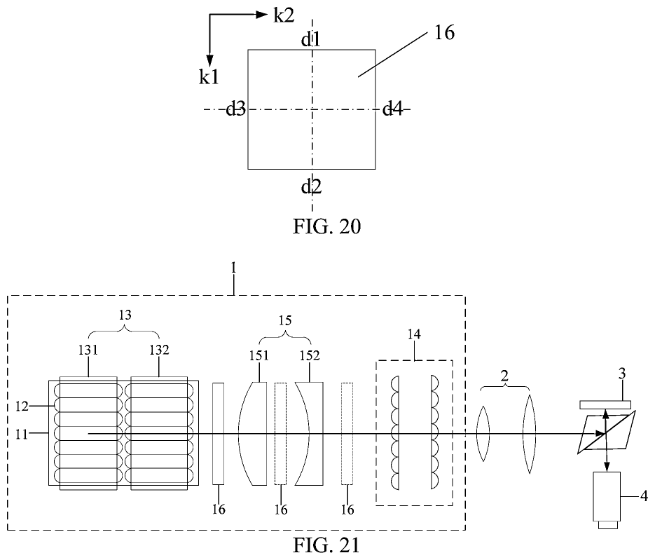

FIG. 13 is a schematic structural diagram of yet another laser light source apparatus according to some embodiments of the present disclosure, and FIG. 14 is a schematic structural diagram of yet another laser light source apparatus according to some embodiments of the present disclosure, FIG. 15 is a schematic structural diagram of yet another laser light source apparatus according to some embodiments of the present disclosure, FIG. 16 is a schematic structural diagram of yet another laser light source apparatus according to some embodiments of the present disclosure, and FIG. 17 is a schematic structural diagram of yet another laser light source apparatus according to some embodiments of the present disclosure, FIG. 18 is a schematic structural diagram of yet another laser light source apparatus according to some embodiments of the present disclosure, and FIG. 19 is a schematic structural diagram of yet another laser light source apparatus according to some embodiments of the present disclosure.

In some embodiments, the laser light source apparatus further includes a diffusion component statically disposed or a diffusion component dynamically disposed, or both. When the laser light source apparatus includes the diffusion component statically disposed, the diffusion component may at least be set as follows. As shown in FIG. 13, the diffusion component 16 is disposed on the light-output side of the laser device 11; or, as shown in FIG. 14, the diffusion component 16 is disposed between the light-combining lens group 13 and the cylindrical convex lens 151; or, as shown in FIG. 15, the diffusion component 16 is disposed between the cylindrical convex lens 151 and the cylindrical concave lens 152; or, as shown in FIG. 16, the diffusion component 16 is disposed on the side of the cylindrical concave lens 152 away from the cylindrical convex lens 151.

When the laser light source apparatus includes the diffusion component dynamically disposed, such as a vibration diffuser, the vibration diffuser 17 may be set as follows. As shown in FIG. 17, the vibration diffuser 17 is disposed on the side of the fly-eye lens component 14 away from the cylindrical concave lens 152; or, as shown in FIG. 18, the vibration diffuser 17 is disposed between the fly-eye lens component 14 and the cylindrical concave lens 152.

In addition, when the diffusion component 16 is disposed on the side of the cylindrical concave lens 152 away from the cylindrical convex lens 151, i.e., between the cylindrical concave lens 152 and the fly-eye lens component 14, referring to FIG. 19, a guiding lens 18 is generally provided between the diffusion component 16 and the fly eye lens component 14 to guide light.

The diffusion component 16 is configured to diffuse the laser light, and under the diffusion effect of the diffusion component 16, the difference between the sizes of the laser spot in the fast axis direction and the slow axis direction can be reduced. The diffusion component 16 can also alleviate the coherence of the laser beams by increasing the diversity of divergence angles of the laser beam, thereby mitigating the scattering effect of the projection picture.

FIG. 10 is a schematic diagram of a planar structure of a vibration diffusion component according to some embodiments of the present disclosure.

As shown in FIG. 10, the diffusion component 16 has a first flip axis d1-d2 and a second flip axis d3-d4. The first flip axis d1-d2 is parallel to the fast axis direction k1 of laser light, and the second flip axis d3-d4 is parallel to the slow axis direction k2 of laser light. In specific implementations, the flip axis of the diffusion component 16 may be flipped by an angle set along the direction perpendicular to the diffusion component, thereby increasing the diffusion effect of the light spots in the direction of the flip axis.

Based on the above principle, in the embodiments of the present disclosure, as shown in FIG. 6, since the size of the entire laser spot row B in the fast axis direction k1 is smaller than the size in the slow axis direction k2, it is necessary to improve the diffusion effect of the laser spots in the fast axis direction k1, so as to increase the size of the laser spots in the fast axis direction k1.

In a possible implementable, the diffusion component 16 may be flipped in the first flip axis d1-d2 by an angle set along the direction perpendicular to the plane where the diffusion component is disposed, and is not flipped in the second flip axis d3-d4, so as to increase the size of the entire laser spot row B in the fast axis direction k1, thereby reducing the difference between the size of the entire laser spot row B in the fast axis direction k1 and in the slow axis direction k2.

In another possible implementable, the diffusion component 16 may be flipped in the first flip axis d1-d2 and the second flip axis d3-d4 by preset angles along the direction perpendicular to the plane where the diffusion component is disposed, respectively, so as to increase the sizes of the laser spot row B in the fast axis direction k1 and the slow axis direction k2. The flip angle of the diffusion component 16 in the first flip axis d1-d2 is larger than the flip angle in the second flip axis d3-d4, such that the increased size of the laser spot row B in the fast axis direction k1 is larger than the increased size of the laser spot row B in the slow axis direction k2, thereby reducing the difference between the size of the entire laser spot row B in the fast axis direction k1 and in the slow axis direction k2.

In another possible implementable, the diffusion component 16 may be flipped at the four endpoints d1, d2, d3, and d4 of the two flip axes in sequence along the clockwise direction or the counterclockwise direction, thereby increasing the sizes of the laser spot row B in the fast axis direction k1 and in the slow axis direction k2. The flip angles of the diffusion component 16 at the two endpoints d1 and d2 of the first flip axis d1-d2 are larger than the flip angles of the diffusion component 16 at the two endpoints d3 and d4 of the second flip axis d3-d4, such that the increased size of the laser spot row B in the fast axis direction k1 is greater than the increased size of the laser spot row B in the slow axis direction k2, thereby reducing the difference between the sizes of the entire laser spot row B in the fast axis direction k1 and in the slow axis direction k2.

In another possible implementable, the diffusion component 16 may be flipped in the first flip axis d1-d2 and the second flip axis d3-d4 by preset angles along the direction perpendicular to the plane where the diffusion component is disposed, respectively, so as to increase the sizes of the laser spot row B in the fast axis direction k1 and in the slow axis direction k2. The flip angle of the diffusion component 16 in the first flip axis d1-d2 is equal to the flip angle of the diffusion component 16 in the second flip axis d3-d4, such that the increased size of the laser spot row B in the fast axis direction k1 is greater than the increased size of the laser spot row B in the slow axis direction k2, thereby reducing the difference between the sizes of the entire laser spot row B in the fast axis direction k1 and in the slow axis direction k2.

The sizes of the laser spot passing through the diffusion component 16 and the shaping lens group 15 are closer in the fast axis direction and the slow axis direction, which is conducive to further homogenization of the laser spots by the fly-eye lens component.

In addition, the diffusion component 16 may also move translationally along the k1 direction or the k2 direction in FIG. 10, and the position on the diffusion component 16 where the laser light is incident changes continuously during the movement of the diffusion component 16. In this way, the energy of the laser light after passing through the diffusion component 16 can be distributed more uniformly, thereby avoiding the interference fringes generated due to the laser speckles and the repetitive structure of the fly-eye lens component.

According to another aspect of the embodiments of the present disclosure, a laser projection system is provided. FIG. 21 is a schematic structural diagram of a laser projection system according to some embodiments of the present disclosure.

As shown in FIG. 21, the laser projection system provided in the embodiments of the present disclosure includes any one of the above laser light source apparatuses 1 provided in the foregoing embodiments, an imaging lens group 2, a light valve modulation component 3, and a projection lens 4. The imaging lens group 2 is disposed on a light-output side of the fly-eye lens component 14 in the laser light source apparatus; the light valve modulation component 3 is disposed on a side of the imaging lens group 2 away from the fly-eye lens component 14; and the projection lens 4 is disposed on a light-output side of the light valve modulation component 3.

The above laser projection system provided in the embodiments of the present disclosure may adopt a digital light processing (DLP) architecture, and the light valve modulation component 3 may be a digital micromirror device (DMD). Image signals are digitized, such that different colors of light emitted in time sequence from the laser light source apparatus are projected on the DMD, the DMD modulates the light based on the digitized signals, and then the light is reflected. Finally, the light is imaged on the projection screen by the projection lens 4. The DMD usually includes a plurality of micro-reflectors.

The laser projection system has a better homogenizing effect of laser light due to the use of the laser light source apparatus provided in the foregoing embodiments.

In the present disclosure, the term “and/or” merely describes an association relationship of associated objects, indicating three kinds of relationships. For example, A and/or B indicate situations: A exits alone, A and B exit simultaneously, and B exits alone. In addition, the character “/” herein generally indicates an “or” relationship between the associated objects. In the present disclosure, the term “at least one of A, B, and C” indicates seven situations: A exits alone, B exits alone, C exits alone, A and B exit simultaneously, A and C exit simultaneously, C and B exit simultaneously, and A, B, and C exit simultaneously. In embodiments of the present disclosure, the terms “first” and “second” are used for descriptive purposes only and are not to be understood as indicating or implying relative importance. The term “a plurality of” refers to two or more, unless otherwise expressly specified. The term “basically” means that within an acceptable error range, a person skilled in the art can solve the described technical problem within a certain error range and substantially achieve the described technical effects.

Described above are merely embodiments of the present disclosure, and are not intended to limit the present disclosure. Within the spirit and principles of the present disclosure, any modifications, equivalent substitutions, improvements, and the like are within the protection scope of the present disclosure.

What is claimed is:

1. A laser light source apparatus, comprising:
a laser device configured to emit different colors of laser light, wherein the laser device comprises at least two different colors of laser chips, the laser chips being arranged in line, and fast axis directions of laser light emitted from the laser chips being parallel to each other; and
a fly-eye lens component disposed in a light path of the laser device, wherein the fly-eye lens component comprises a plurality of microlenses arranged in an array, and each of the microlenses extends along a first dimensional direction and a second dimensional direction, the second dimensional direction being perpendicular to the first dimensional direction;
wherein a laser spot emitted from the laser device to a light-incident side of the fly-eye lens component has an NA value in a slow axis direction and an NA value in a fast axis direction, the NA value in the slow axis direction is less than an NA value of at least one of the microlenses in the first dimensional direction, and the NA value in the slow axis direction is less than an NA value of at least one of the microlenses in the second dimensional direction; the fast axis direction of the laser spot is parallel to the first dimensional direction, and the slow axis direction of the laser spot is parallel to the second dimensional direction; and a Lagrangian invariant of a laser beam in the fast axis direction is smaller than a Lagrangian invariant of the laser beam in the slow axis direction.

2. The laser light source apparatus according to claim 1, wherein a size of a far-field spot formed by the laser light after passing through the fly-eye lens component is positively associated with a Lagrangian invariant.

3. The laser light source apparatus according to claim 1, wherein a size of each of the microlenses in the first dimensional direction is smaller than a size of each of the microlenses in the second dimensional direction.

4. The laser light source apparatus according to claim 1, wherein a size of each of the microlenses in the first dimensional direction is larger than a size of each of the microlenses in the second dimensional direction.

5. The laser light source apparatus according to claim 1, wherein the fly-eye lens component comprises a microlens array disposed on a light-output side or two microlens arrays disposed on a light-incident side and a light-output side.

6. The laser light source apparatus according to claim 1, wherein
a projection of an outer contour of each of the microlenses in an optical axis direction is rectangular, and long side directions of the plurality microlenses are parallel to each other; or
a projection of an outer contour of each of the microlenses in an optical axis direction is hexagonal, and short sides of two adjacent microlenses are in a same straight line or parallel to each other.

7. The laser light source apparatus according to claim 1, wherein the different colors of laser light comprise a red laser beam, a blue laser beam, and a green laser beam; wherein
an NA value of the red laser beam in the slow axis direction is greater than an NA value of the blue laser beam in the slow axis direction and is greater than an NA value of the green laser beam in the slow axis direction, and the NA value of the red laser beam in the slow axis direction is smaller than an NA value of at least one of the microlenses in the slow axis direction.

8. The laser light source apparatus according to claim 1, wherein the laser device comprises red laser chips, green laser chips, and blue laser chips; wherein
the red laser chips, the green laser chips, and the blue laser chips are arranged in an array, and the red laser chips, the green laser chips, and the blue laser chips are arranged in at least one row;
wherein a number of the red laser chips is greater than a number of the green laser chips and is greater than a number of the green laser chips; and the number of the red laser chips is less than or equal to twice a sum of the number of the green laser chips and the number of the blue laser chips.

9. The laser light source apparatus according to claim 8, wherein
the red laser chips, the green laser chips, and the blue laser chips are arranged in one row; or
the red laser chips are arranged in one row, and the green laser chips and the blue laser chips are arranged in one row; or
the red laser chips are arranged in two rows, the green laser chips are arranged in one row, and the blue laser chips are arranged in one row.

10. The laser light source apparatus according to claim 8, wherein the laser spot covers more microlenses in the slow axis direction than in the fast axis direction.

11. The laser light source apparatus according to claim 8, wherein the laser device further comprises:
a plurality of collimating lenses disposed on a light-output side of the laser chips and configured to collimate laser light emitted from the laser chips, wherein one of the collimating lenses corresponds to at least one of the laser chips.

12. The laser light source apparatus according to claim 11, further comprising: a light-combining lens group disposed on the light-output side of the laser device; wherein
the light-combining lens group comprises a plurality of light-combining lenses, one row of laser chips corresponds to at least one of the light-combining lenses, and the light-combining lens group is configured to combine laser light emitted from the laser chips;
wherein the fly-eye lens component is disposed on a light-output side of the light-combining lens group.

13. The laser light source apparatus according to claim 12, further comprising:
a shaping lens group disposed on a light-output side of the light-combining lens group, wherein the shaping lens group is configured to shape laser light emitted from the light-combining lens group.

14. The laser light source apparatus according to claim 13, wherein the shaping lens group comprises:
a cylindrical convex lens disposed on a side close to the light-combining lens group; and
a cylindrical concave lens disposed on a side of the cylindrical convex lens away from the light-combining lens group;
wherein cylindrical axial direction of the cylindrical convex lens and the cylindrical concave lens are parallel to a fast axis direction of incident laser light.

15. The laser light source apparatus according to claim 13, wherein the shaping lens group comprises:
a convex lens disposed a side close to the light-combining lens group; and
a concave lens disposed on a side of the convex lens away from the light-combining lens group;
wherein axial directions of the convex lens and the concave lens are parallel to a fast axis direction of incident laser light.

16. The laser light source apparatus according to claim 14, further comprising: a diffusion component, wherein the diffusion component is configured to diffuse laser light, and is provided in one of the following positions: on the light-output side of the laser device, between the light-combining lens group and the cylindrical convex lens, between the cylindrical convex lens and the cylindrical concave lens, and on a side of the cylindrical concave lens away from the cylindrical convex lens.

17. A laser projection system, comprising: a laser light source apparatus,
a light valve modulation component disposed on a light-output side of the laser light source apparatus, and
a projection lens disposed on a light-output side of the light valve modulation component; wherein
the laser light source apparatus comprises:
a laser device configured to emit different colors of laser light, wherein the laser device comprises at least two different colors of laser chips, the laser chips being arranged in line, and fast axis directions of laser light emitted from the laser chips being parallel to each other; and
a fly-eye lens component disposed in a light path of the laser device, wherein the fly-eye lens component comprises a plurality of microlenses arranged in an array, and each of the microlenses extends along a first dimensional direction and a second dimensional direction, the second dimensional direction being perpendicular to the first dimensional direction;
wherein a laser spot emitted from the laser device to a light-incident side of the fly-eye lens component has an NA value in a slow axis direction and an NA value in a fast axis direction, the NA value in the slow axis direction is less than an NA value of at least one of the microlenses in the first dimensional direction, and the NA value in the slow axis direction is less than an NA value of at least one of the microlenses in the second dimensional direction;
the fast axis direction of the laser spot is parallel to the first dimensional direction, and the slow axis direction of the laser spot is parallel to the second dimensional direction; and a Lagrangian invariant of a laser beam in the fast axis direction is smaller than a Lagrangian invariant of the laser beam in the slow axis direction.

18. The laser projection system according to claim 17, wherein a size of a far-field spot formed by the laser light after passing through the fly-eye lens component is positively associated with a Lagrangian invariant.

19. The laser projection system according to claim 17, wherein a size of each of the microlenses in the first dimensional direction is smaller than a size of each of the microlenses in the second dimensional direction.

20. The laser projection system according to claim 17, wherein a size of each of the microlenses in the first dimensional direction is larger than a size of each of the microlenses in the second dimensional direction.
